(19) United States
(12) Patent Application Publication
(10) Pub. No.: US 2016/0368781 A1
(43) Pub. Date: Dec. 22, 2016

(54) WASTE FILTRATION SYSTEM

(71) Applicant: International Wastewater Heat Recovery Systems Inc, Port Coquitiam (CA)

(72) Inventor: Lynn Mueller, Vancouver (CA)

(21) Appl. No.: 14/360,884

(22) PCT Filed: Mar. 14, 2014
(86) PCT No.: PCT/CA2014/000238

§ 371 Date: May 27, 2014

(30) Foreign Application Priority Data
Mar. 18, 2013 (CA) 2809727

(51) Int. Cl. C02F 1/00; B01D 29/64; F25B 30/06; B01D 29/35

(52) U.S. Cl. CPC C02F 1/004; B01D 29/35; B01D 29/6476; F25B 30/06; B01D 2201/08; C02F 2303/10; C02F 2303/16

(57) ABSTRACT

A waste filtration system is provided, suitable for separating waste content in a waste stream, for use in heat recovery, including a filter screen, auger and extractor pump. A novel filtering process includes steps of adjusting extraction rate of waste content by feedback measurement such that a target set-point is maintained. The feedback control is provided by either use of a variable speed motor detecting load change on the auger or sensors correlated to waste content, and displacement type extraction pump The waste filtration system can be used in a closed loop without leaks or open waste. The resulting filtered fluid is suitable for improving performance in heat exchange and recovery arrangements.

### FIELD OF THE INVENTION

The invention relates to fluid filtration systems. In particular, this invention relates to a waste filtration system. The invention is best suited for the filtration of waste streams for heat recovery.

### BACKGROUND OF THE INVENTION

Waste heat recovery is a sustainable source of recovered energy, with waste processing and waste streams such as municipal sewage being widely distributed. The primary challenges in the widespread adoption of waste heat recovery is to efficiently separate out particulate sufficient for a cleaned stream to be used in heat extraction systems, where an acceptable waste content level is desirable. Various filtration systems have been exploited for this purpose. One major drawback with traditional filtration systems however, is having open waste extraction, leaks and frequent maintenance and limited continuous control of output waste content. Filtration systems for inline continuous separation of particulate from waste stream conventionally require manual intervention to scrape and remove waste, solids and obstructions. A review of relevant control systems in waste filtration are described.

Augers and screws arrangements have commonly been used in extractors, compactors and presses, including sometimes fit within filter sleeves or meshes such that water can flow out of the mesh and be separated. Such applications with high viscosity are only tangentially applicable but included for completeness of alternative examples. Examples of some of these designs are shown in U.S. Pat. Nos. 4,260,488, 4,871,449, and published applications 20110011283, 2011110810. Several of these use a variable speed motor to drive the auger but the auger in the examples above is the primary “driver” of removing the waste or heavier sludge in some cases, as discussed in more detail below.

There have been some approaches for feedback control of waste stream filtering, but limited in utility for waste stream continuous filtering. An apparatus for treating sludge is disclosed in U.S. Pat. No. 7,335,311, having a feedback control of the variable speed auger motor which is adjusted to control the flow of sludge out of the system (sludge is much more viscous than waste water and a press for sludge removal or dewatering is a different application but is included for completeness as an auger based system with control). The variable speed motor adjusts auger speed to control the waste flow rate in response to torque on the drive shaft, sludge content or pressure in the sludge. Such as system would not be useful or applicable for high rate continuous waste water filtration, as the press does not provide filtering out a small amount of waste content at high flow rates to provide a low waste content stream but compressing solid sludge waste for removal. Varying the auger speed is the primary “driver” with limited control range for low waste content streams.

A patent publication, US20110011283, has a variable speed motor with the auger speed responding to either an upstream feedstock piston actuator (rate of feed) or a second stage compression piston (rate of compacting). The control feedback is limited to the application process for feedstock processing—maintaining a rate of feed of a compacted feed. In applications such as sewage lines there is a need to respond to incoming flow rates which may not be adjustable. Also this system maintains a feed rate for efficiency but does not provide feedback control determined by outgoing filtered water waste content level.

Few relevant examples were found for waste stream filtration with dynamic control of waste content level suitable for heat recovery systems. There is a need for a system with continuous dynamic extraction of waste from a waste stream in a closed loop sealed system, maintaining waste content level suitable for heat recovery.

Hence, there is a need to provide a novel method of precision control of waste extraction from a waste stream at low content levels.

### SUMMARY

A filtration system is provided for the purpose of extracting waste content below a set level. The waste extraction system consists of a housing having an inner chamber, including fluid inlet port sealably couplable to an incoming waste stream, fluid outlet port sealably couplable to an outgoing fluid conduit, extraction port, and a drive port. Further including; a substantially cylindrical filter sleeve seated within the chamber between the drive and extraction ports, and in contact with the fluid inlet port and having an inner diameter and at least a portion of sides and bottom perforated, an auger having a rotatable helical shaft with an diameter substantially corresponding to the inner diameter of the filter, wherein the shaft is rotatably couplable through the drive port, a waste extractor coupled to the extraction port controllable to provide variable negative pressure within the chamber, a motor coupled to the auger shaft for rotating the auger to separate waste, and translate waste towards the extraction port, a waste content sensor, a computer connected to the waste content sensor, motor and waste extractor and stored data to correlate load sensor readings to a waste content level, Such that the rate of waste extraction is controlled by computer to maintain the waste content level below a set-point, such that the outgoing stream has low waste content.

An embodiment of a filtration system incorporating heat recovery from a waste stream is provided including;a waste filtration system receiving incoming stream from the waste stream, and automatically and continuously controlling waste extraction to maintain waste content below a threshold suitable for heat exchanger use, a heat exchanger fluidically coupled to the waste filtration system for receiving outgoing filtered stream from the waste filtration system, and delivering a return cool stream back to the waste stream, a chiller heat pump fluidically coupled to the heat exchanger for receiving the warm stream and returning a cool stream, such that the coefficient of performance of the chiller heat pump is increased.

An additional detailed embodiment of a system is further provided, including the substitution of a geothermal exchange for the chillier heat pump.

A preferred embodiment has a variable speed motor with frequency shift sensing that measures auger load correlated to the waste content level, allowing for precision feedback control. Most significantly the waste extractor is displacement type and applies controllable rate of extraction to reduce waste content level, while remaining sealable and able to extract large content.

Additional benefits of using the waste filtration system compared to existing solutions include, the control of displacement pump extraction rate by speed sensing of the auger, providing a closed processing loop for waste extraction and replacement. In comparison to alternate filter systems, the waste filtration system has self cleaning features to manage fibrous or large waste, enabling extended use before replacement of parts. Finally, significant performance improvement is provided to heat exchange systems from the recovered heat from a previously challenging to extract effectively from, source of continuous heat.

### BRIEF DESCRIPTION OF THE DRAWINGS

FIG. 1 is a cutaway front view illustration of a waste filtration system, showing auger separator and waste extractor pump, and a vertical orientation.

FIG. 2 is a perspective view of a waste filtration system, showing the drive port and variable speed motor drive.

FIG. 3 is a side view of a waste filtration system, showing the extractor port and details of the waste extractor.

FIG. 4 is a detailed sectional view of the inner chamber components and operation, specifically auger and filter cup arrangement.

FIG. 5 is an exploded view of a displacement pump (lobe pump).

FIG. 6 is a schematic of the waste filtration system, specifically control of waste extractor in response to measurement from variable speed motor.

FIG. 7 is a flowchart of a process for feedback control of the waste filtration system.

FIG. 8 is a flowchart of a process for feedback control of the waste filtration system, with additional steps to program target setpoints for waste content removal.

FIG. 9 is a schematic of the waste filtration system, specifically control of waste extractor in response to additional sensors monitoring parameters related to waste content or viscosity.

FIG. 10 is a schematic of the waste filtration system used in a heat exchange loop for heat recovery from a waste stream, including closed loop recycling of removed waste.

FIG. 11 is a schematic of the waste filtration system used in a heat exchange loop for heat recovery from a waste storage tank, including optional closed loop recycling of removed waste.

FIG. 12 is a schematic of the waste filtration system used in a geothermal heat exchange loop for heat recovery from a waste storage tank, including optional closed loop recycling of removed waste.

FIG. 13 is a schematic of the waste filtration system used in a direct refrigeration heat exchange for cooling from a waste storage tank, including optional closed loop recycling of removed waste.

### DETAILED DESCRIPTION

A filtration system for waste processing and effective heat exchange, receives a fluid stream, processes, filters and separates the waste to reduce the viscosity and solid content of an outgoing filtered stream, while not effecting heat content of the waste stream, such that the filtered stream can be used for heat exchange or recovery.

Realizing benefits of such waste filter system has to overcome challenges of effectively separating waste then remixing it for closed loop, automated removal over a range of waste content, and self cleaning automation. As outlined earlier these challenges include, components that can operate under waste stream contraints, and feedback control that is reliable and effective.

In terms of general orientation and directional nomenclature, two types of frames of reference may be employed. First, inasmuch as this description refers to screws, augers or screw compressors, it may be helpful to define an axial or z-direction, that direction being the direction of advance of filtered or separated material along the screw when turning, there being also a radial direction and a circumferential direction. Second, in other circumstances it may be appropriate to consider a Cartesian frame of reference. In this document, unless stated otherwise, the x-direction is the direction of flow of waste stream through the machine, and may typically be taken as the longitudinal centerline of the various feedstock flow conduits. The y-direction is taken as a horizontal axis perpendicular to the x-axis. The z-direction is generally the vertical axis. In general, and unless noted otherwise, the drawings may be taken as being generally in proportion and to scale.

The present embodiments are described using terms of definitions below:
“Filtration,” as the term used herein, is the process of removing waste particulate, fibers and solids from a fluid.
“Waste stream,” as the term used herein, is a fluid containing waste particulate, fibers and solids, human waste. This may also be termed sewage waste or feedstock in Waste separation” as the term used herein is to remove or reduce waste content from a waste stream, such that the filtered to a suitable viscosity level for further processing. In general the embodiments apply to modest levels of waste typical in municipal sewage and not heavy sludge waste.

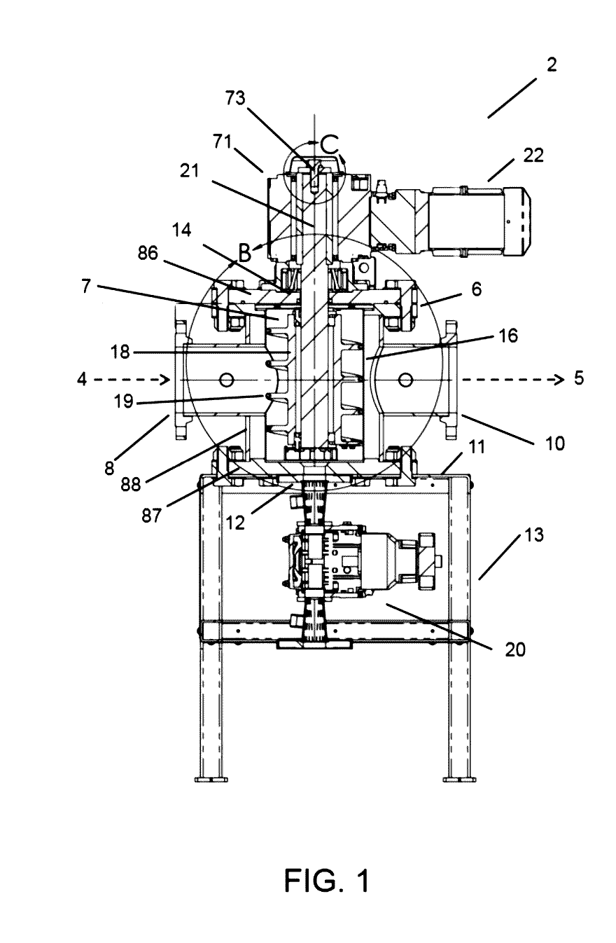

A filtration system 2 is shown in general arrangement in FIGS. 1, 2, 3. Filtration system 2 includes a housing 6 mounted to a base plate 11, which is mounted to frame 13. The housing 6 has inner chamber 7 and 4 ports. The housing 6 is alternatively formed with an open cylinder 88, secured by top and bottom endcaps 86, 87 in a sealable design as shown in FIG. 1, having respective port holes substantially in the center of each endcap. The housing 6 may be formed of metal or plastic that meets pressure requirements (similar to sewage line pressure), and is formed to suitable tolerances for integrity of holding the filter sleeve, and sealing the top and bottom endcaps. In the direction of flow of a incoming waste stream 4 (conduit not shown), fluid inlet port 8 is sealably couplable to an incoming conduit (not shown), and fluid outlet port 10 is sealably couplable to an outgoing conduit (not shown), receiving filtered stream 5. In the preferred embodiment these fluid ports and direction of flow are along the x-axis horizontally.

The inner chamber 7 is preferably cylindrically shaped, to retain a corresponding cylindrical filter sleeve 16 in the central region of the chamber. Preferably the chamber is hermetically sealed. The chamber 7 is alternatively formed within an open cylinder 88, secured by top and bottom endcaps 86,87 in a sealable design as shown in FIG. 1, having respective port holes substantially in the center of each endcap. The filter sleeve 16 is perforated and could be formed as a perforated sheet or mesh, providing a similar filtering function. The bottom of the filter sleeve is in contact with the bottom of the inner chamber 7 (bottom endcap 87). As shown, there is a recess 39 in bottom endcap 87 for receiving the sleeve 16 such that solids are restricted from exiting from within the filter sleeve except through an extraction port 12 at the bottom. The top of the filter sleeve 16 is in contact with top endcap 86, the endcap having a recess 91 to retain and hold the sleeve such that solid waste in the waste fluid does not escape from within the filter sleeve except through the extraction port 12 at the bottom. The perforation sizing of filter sleeve 16, is selected for trapping expected particulate/solids in the incoming waste stream 4. At least a portion of the sides are perforated. Preferably the perforation is similar throughout the sleeve. For the purpose of filtering the incoming waste stream 4 is delivered directly to the filter sleeve 16, as the chamber side of the fluid inlet port 8 is substantially in contact with the sleeve such that fluid entering the chamber may substantially go through the sleeve for filtering. The diameter of the filter sleeve is selected to match the auger diameter. With the exception of the fluid inlet port 8 region, there is a gap between the sleeve and the inner chamber walls (unnumbered) (for the purpose of allowing some flow that self-cleans solids pushed out of the perforated holes).

As solids are retained within the sleeve, there is a need to further separate the solids for extraction, for which an auger or screw is ideal for directionally urging or pushing solids along the screw axis. An auger 18 includes a volute (auger blades 19) and auger shaft 21, and is positioned within the filter sleeve 16 to help separate the solids by directing them downwards. Auger 18 may include a volute having a variable pitch spacing between the individual flights or turns of the volute, either as a constant step function as in the embodiment illustrated, or in an alternative embodiment having a continuously decreasing pitch spacing as the tip of the screw is approached in the distal, downward or z-direction. Auger 18 has a diameter corresponding to the inner diameter of sleeve 16 such that the edge of auger blades 19 are concentric with and in contact with the filter sleeve and scrape it when the auger is rotated. In an alternate embodiment the auger blades 19 are close but not in contact with the filter sleeve. In a preferred embodiment the auger is not tapered or may have a very slight taper. In an alternative embodiment both the filter sleeve and auger are correspondingly tapered. The sleeve and rotating auger together provide the core filtering of waste fluid, and a novel method of control of the rate of extracting this filtered waste is described that may require measurement of the waste content level of the fluid within the sleeve.

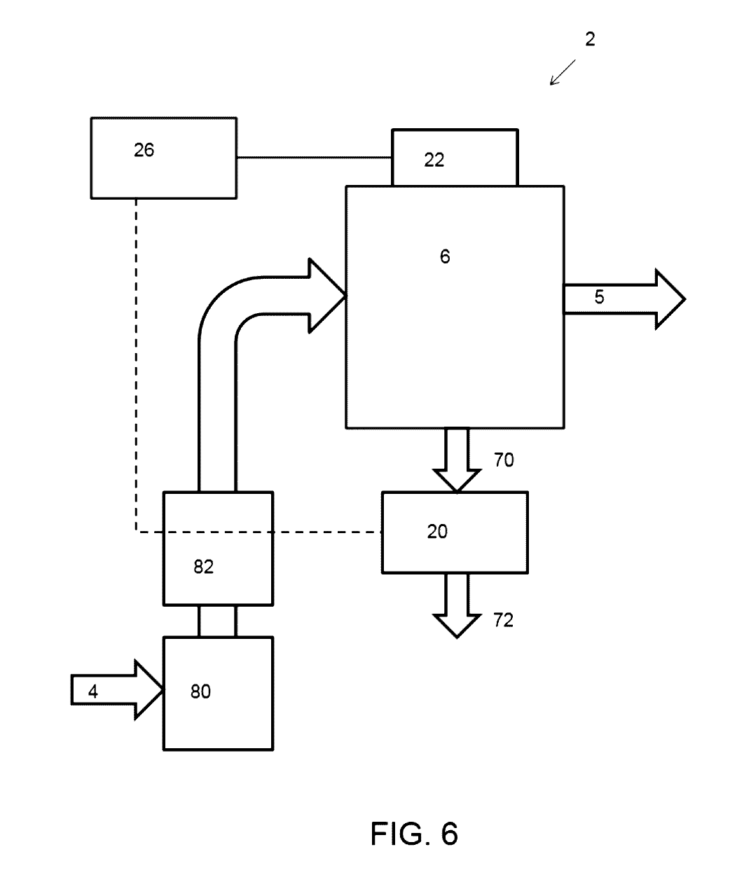

The auger shaft 21 extends out from the filter cup and is sealably couplable through drive port 14, to a motor 22, controllable to vary the auger rotation speed, and connected to a controller (shown in FIG. 6). Motor 22 may be a variable speed motor, and may include speed sensing, monitoring, and control apparatus operable continuously to vary output speed during operation. The variable speed motor 22 may be for example, types available from Sumitomo. Alternatively, motor 22 may be a geared motor, and may include a reduction gearbox.

The auger 18 is shown vertically suspended from drive port 14 coupling to the variable speed motor 22. At the bottom of the chamber the auger length leaves a small gap sufficient for separated waste to move, slide or flow into the extraction port 12. Optionally, additional small propeller blades 74 are attached at the distal end of the auger for further directing the solid waste. The detail of inlet port 8 extending to contact filter sleeve 16 is shown as the segment 42 of port internal to the chamber extends to and contacts the filter sleeve 16 as shown. A drive port coupling to the auger, for a particular embodiment, is detailed further. The base or proximal end of auger 18 is mounted in a bearing 35, or a compression screw bearing housing assembly 34 having a flange that is mounted to top of chamber. The keyed input shaft of auger 18 is driven by the similarly keyed output shaft (not numbered) of drive or reducer, torque being passed between the shafts by coupling (unnumbered). A wiper rod 37 keeps the shaft clean. Locking washers 38 assist with coupling top endcap 86 to cylinder 88. A novel design allows for rapid easy removal of the auger 18 from the filtration system 2, for replacement or cleaning in 2 steps. First the top endcap 86 associated with drive port, is removable by releasing the bolts (unnumbered) securing it to the cylinder 88, then auger screw (bolt) 73 on top of auger 18, is undone which releases shaft 21 to release auger 18 which is simply pulled out the filtration system, along with filter sleeve 16. A replacement auger can be substituted by the process in reverse. The filter screen is seated within recess 39 to contain the extracted waste. Benefit of rapid auger replacement include that the filtration system 2 is offline for a very short period of time, and also that other components do not automatically have to be replaced each time, reducing costs. A novel benefit of this design is rapid and convenient replacement of sleeves by removing the motor 22 and auger 18, top cap 86 to access and replace the filter sleeve 16 and reassemble within the sealed chamber 7.

In a preferred embodiment, the auger blades 19 have a spring loaded scraper 75, such that there is a compression fit between the auger blades 19 and inner surface of the filter sleeve 16. This improves scraping and cutting fibrous waste so it can be easily cleared out of the perforations in filter sleeve 16—either inside the sleeve or cut away outside and exiting through fluid outlet port 10. The spring loaded scraper 75 is preferably made of spring loaded metal such as brass for durable operation.

The filtered waste may be removed from inside the sleeve, and an extraction port 12 having a variable rate of extraction is provided. Extraction port 12 is located at the bottom of the chamber 7, substantially centered near rotation axis of auger 18. In an embodiment, extraction port is formed as part of endcap 87. The port is sealably couplable to a waste extractor 20 outside the chamber. The waste extractor 20 provides a controllable negative pressure or vacuum to extract waste from inside the filter sleeve through the bottom of the chamber. The waste extractor 20 is connected to controller 26 (in FIG. 6) and controllable to vary the rate of extraction. The waste extractor 20 is selected from a preferred category of positive displacement pumps, such as those manufactured by vogelusa.com. This category includes lobe pumps, progressive cavity pumps, vane pumps and gear pumps. These pumps may include a extractor pump motor 23 for controlling the pump speed and vacuum. The waste extractor pump, provides various benefits to the filtration system, (in comparison to conventional pumps). Specifically for the preferred type of lobe pump, a first benefit is there is no varying fluid bypass with changes in pressure, hence, the pump has limited or no leakage while applying a vacuum to a low viscosity fluid. A second benefit is the pump allows large solids or waste to be removed and extracted without stopping operation to clean the pump, for example socks or clothing. A class of pump types provides an unusual and unexpected solution to the needs of the waste water processing, in particular for suitably sealing leaks of the fluid, extracting solid waste without much fluid, and passing through large solid waste objects.

The waste stream (such as sewage waste) typically has a particulate waste content of under 5%, and is ideally processed to provide a target content less than 5%, having a corresponding waste content level setpoint which is stored in controller 26. The waste content level is correlated to waste content by weight or volume, and can be determined by a wide range of sensors including pressure difference, turbidity, flow rate, and mechanical load. This is referred also as the “waste level”. The waste content level of incoming waste stream, is variable and when it exceeds the setpoint is unusable and problematic for heat recovery use.

The waste filtration system 2 can be coupled to a waste stream 4 from municipal sewage, or local sewage storage or other forms of liquid waste. The filtration system operates as follows. The incoming waste stream 4 enters the inner chamber 7 through fluid inlet port 8 under pressure, and flows through incoming side of the filter sleeve and around the auger and out the regions of the sleeve not in contact with inlet port 8, flowing out through the fluid outlet port 10 as outgoing filtered stream 5. The rotating auger separates solids, particulates from the fluid by urging and compacting the heavier solids downwards towards and out of the waste hole. The faster the auger speed the more particulates are separated and the lower viscosity and waste content of the outgoing filtered stream. The auger speed is preferably maintained at a constant rate while the extraction is controlled by the waste extractor. In alternative embodiments the auger speed and extraction speed can be dependently varied to meet the target viscosity set point. Incoming streams with more waste content create greater load on the auger 18, which is measured by the built-in variable speed sensor of the motor 22, acting as a “waste level” load sensor 24. The separation is also facilitated by gravity acting on the solids and particulates. The most significant separation control is the rate of extraction by the waste extractor pump.

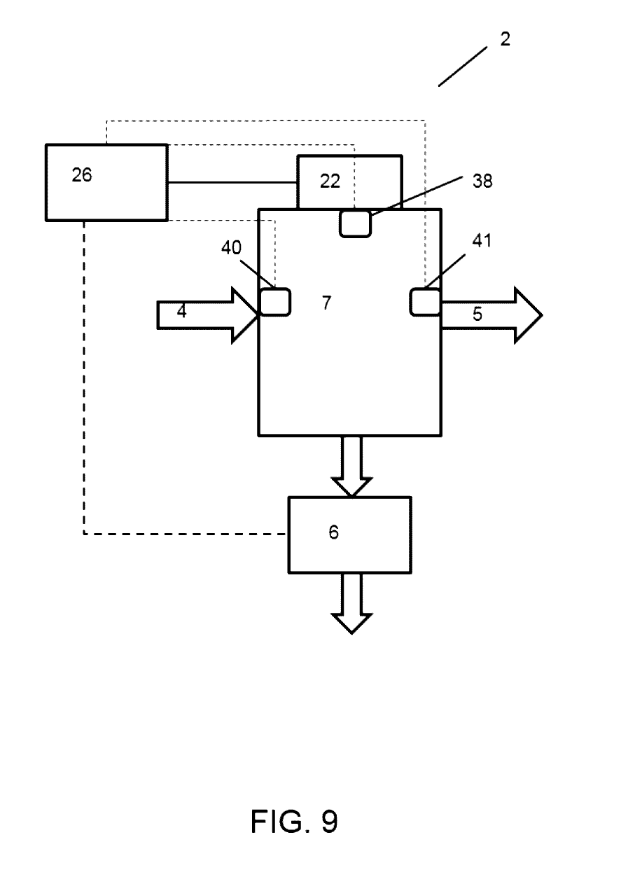

A novel feedback control method is provided to automatically maintain the outgoing filtered waste content below a setpoint stored by the controller. The preferred and simplest feedback control is to correlate the mechanical load on the auger by sensitive measurement of auger speed intrinsically measured and output by variable speed motor 22, to a waste content of the fluid within the filter sleeve 16. This is done by calibrating the filtration system 2 for measured waste content or viscosity and programming target set-points into the controller 26. When the load increases above a target set-point correlated to maximum waste level, the controller 26 (FIG. 6) instructs waste extractor 20 to increase the extraction rate (increased vacuum or negative pressure), until the load measured on auger 18 returns to below the setpoint (i.e. a measured shift in frequency of motor drive is correlated to a waste content level, and extraction rate increased until the frequency shift of the motor drive is reduced suitably). Alternative sensing and feedback control for the same purpose is discussed in FIG. 9, which enables using a constant speed motor (unnumbered). This feedback control quality makes the waste filtration system 2 eminently suitable for use in applications requiring high reliability, limited servicing and closed loop automated filtration of varying characteristics of incoming waste streams. Specifically, applicants have achieved continuous feedback control and operation suitable for use in municipal scale commercial operations.

Hence, to meet the needs described, a novel system design is provided that contains has dynamic viscosity feedback control and continuous filtering of waste water to be practically and commercially realized. Such system maintains exit viscosity or “waste level” under a target setpoint, stable in use, maintains water clean and finally has suitable properties for reliable repeated use over long use cycles (years) common in continuous municipal or industrial heat extraction systems.

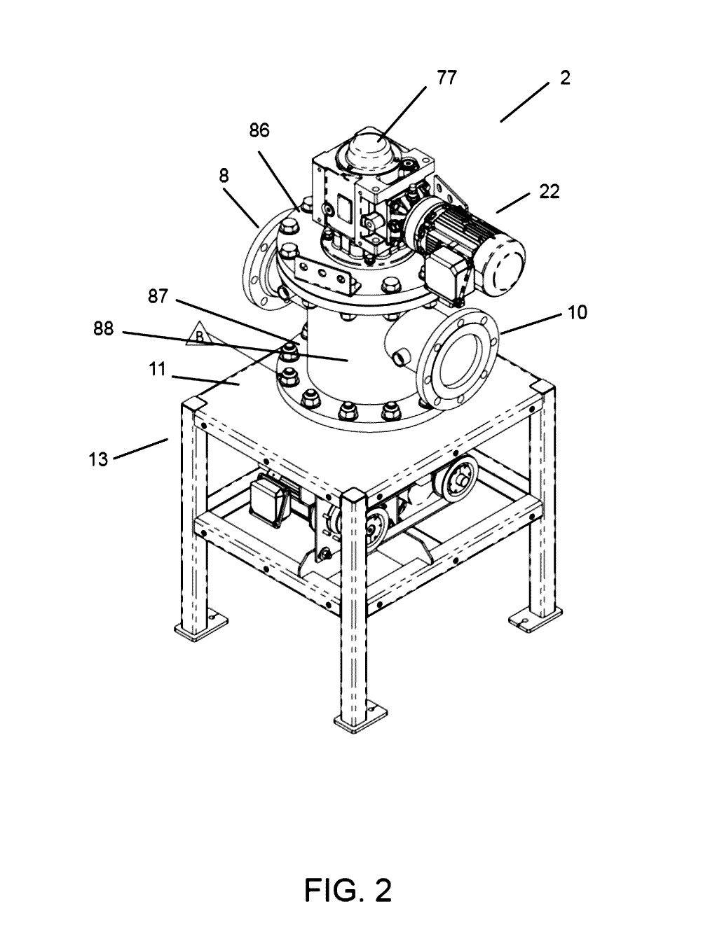

FIG. 2 shows simplified detail of the components of the waste filtration system 2 mounted on frame 13 by baseplate 11. Specifically the variable speed motor 22 is coupled to the auger shaft 21 (extending through drive port 14) of auger 18 and mounted to the top plate of housing 6 (endcap 86). The bolts (unnumbered) securing endcap 86 to cylinder 88 may be released to remove top endcap 86. The auger screw 73 is underneath topcap 77. Fluid outlet port 10 and fluid inlet port 8 are shown with a flange and sealable coupling as suitable for standardized municipal sewage conduit coupling.

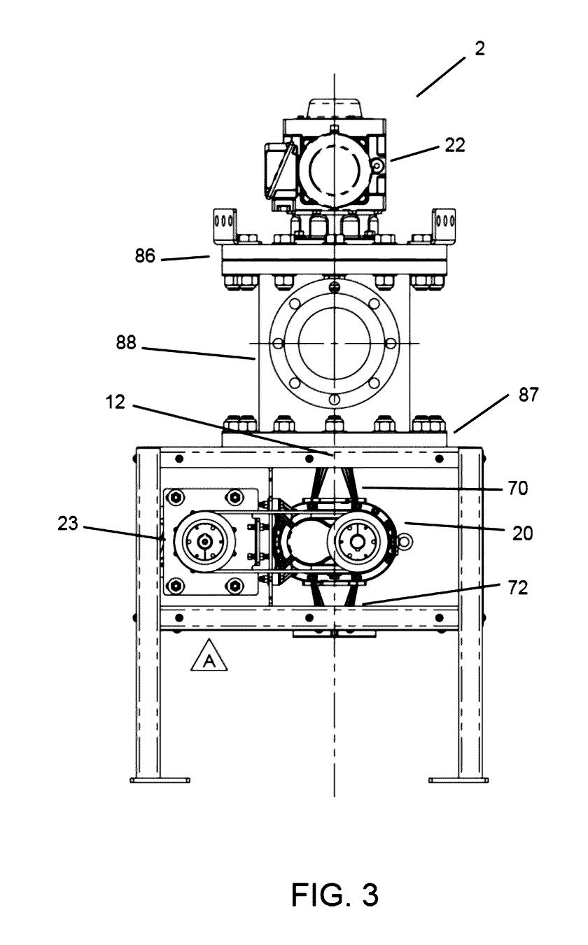

FIG. 3 illustrates a side view of waste filtration system 2, with further detail of the waste extractor section. Waste extractor 20 (displacement pump) is coupled to extractor port 12 through extractor pipe (or conduit) 70 to provide vacuum inside chamber 7. In this preferred embodiment shown, disposal pipe (or conduit) 71 faces downward for either disposing of extracted waste to a container, or coupling to a return mixing conduit (not shown). The frame 13 is positioned at a height leaving space for either disposal. An extractor pump motor 23 is shown coupled to waste extractor 20 for driving pump speed in the illustrated embodiment by a drive pulley. Extractor pump motor 23 and is connected to a controller 26 (FIG. 6) such that pump drive speed and extraction rate is responsive to the controller 26. Attempted use of waste filtration systems with auger and extraction done horizontally were found unsatisfactory, as requiring very frequent manual cleaning and manual removal of waste, potential leaks, challenging removal of filter sleeves and not meeting needs of waste facilities. The preferred vertical design assists low maintenance and greatly reduces halting operation for cleaning.

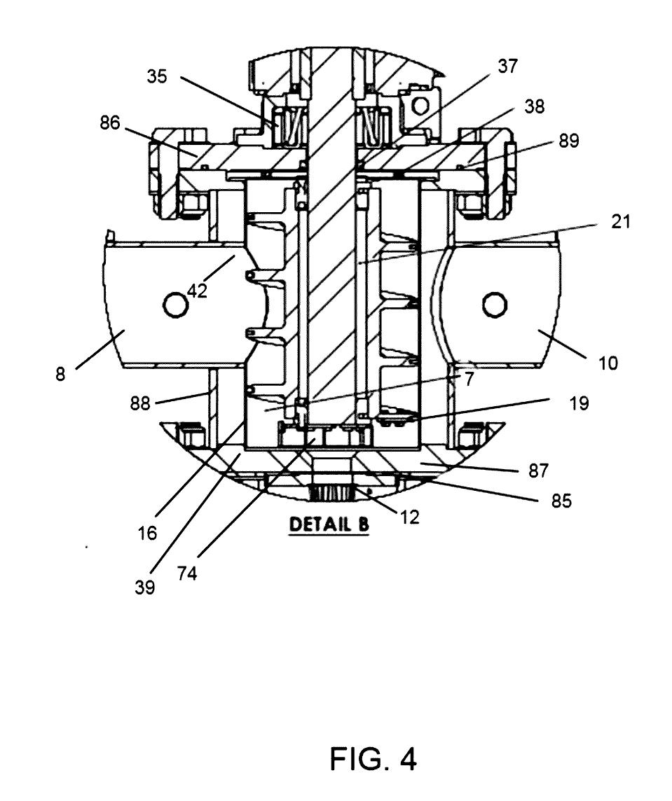

FIG. 4 shows an illustration of additional detail of the elements and arrangements within the chamber 7 of housing 6 of waste filtration system 2. Top endcap 86 has a drive port 14 through which auger shaft 21 is rotatably and sealably coupled by a rotation bearing housing assembly 34. Cylinder 88 of housing 6 has outwardly extending flange regions (unnumbered) at each end for coupling to the endcaps by bolts (unnumbered) and for providing a sealing surface. O-ring 89 provides sealing between the top endcap seated on the top flange of cylinder 88, with a gasket 85 providing sealing for the bottom endcap 87 seated on bottom flange of cylinder 88. Bottom endcap has the recess 39 for seating filter sleeve 16 and extraction port 12. The auger 18 (or auger assembly) shows volute with blades 19 equally spaced, and a blade pitch for directing the solid waste downwards. The blade scrapers 75 are seated in the tip of auger blades 19 and preferably spring loaded. Propeller or paddle blades 74 are optionally and preferably secured at the bottom end of the auger, angled to guide waste to the extractor port. The filter sleeve 16 is registered and sealed by seating in the recess 39 in bottom endcap 87, and seated registration within top flange opening of cylinder 88 and contained by a washer plate 36 under top endcap 86, so there is no bypass of fluid around the sleeve and also to provide a precision fit registration of the sleeve and corresponding auger for a contact fit in the preferred embodiment. The expanded view shows how the inlet port 8 extends within chamber 7 to contact the filter sleeve 16, whereas the outlet port does not extend within the chamber, receiving unrestricted outgoing fluid from the larger “filtering area” of the sleeve, and carrying away any “sliced waste” cut away outside the sleeve by the blade edges. This design aspect is critical to the longevity between cleaning of the sleeve and auger, and has been shown to have a dramatic performance improvement of years between cleaning versus days with conventional design. The design has user replaceable components, where the auger and then sleeve are easily released and removed and replaced.

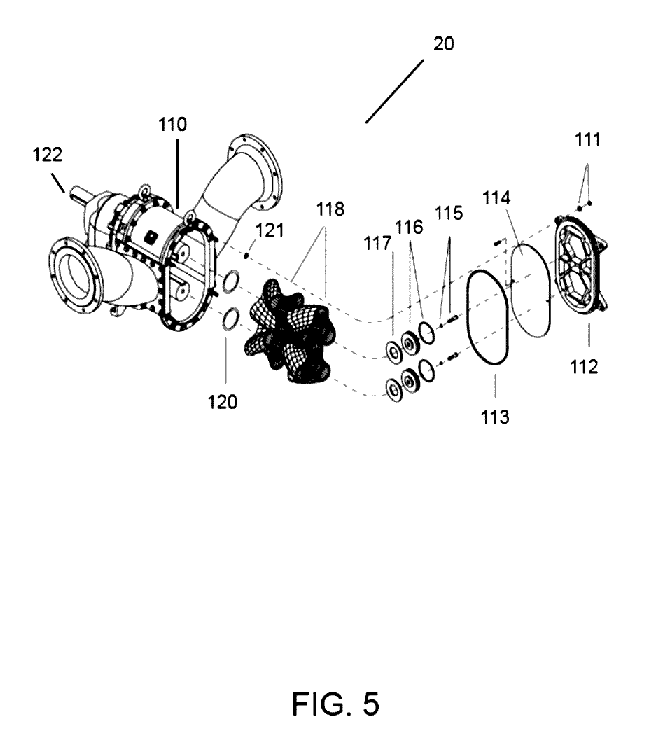

FIG. 5 shows an expanded view of components of an available lobe displacement pump for illustration of operation. Pump body 110 has inlet conduits X and outlet conduit Y setting a direction of flow transverse across lobes 118. The assembly includes cover plate 112, nuts 111, plate 114 and o-ring 113. Strain screws 115, pressure disk 116 and spring washers 117 couple to the front of the lobes subassembly 118, and washers 120,121 fit on the rear to two registration pegs within body 110. The displacement lobes mesh together during operation, while rotating in the opposite directions. This rotation forms cavities between the rotors and the casing (cavity inside body 110). Optionally convoluted lobes can be coated with an elastomer (not numbered) that provide compression to convey the fluid to the opposite side of the pump. The lobes 118 provide pulsation free flow, and increased wear life, and can transfer large waste objects with minimal flow leakage. The lobes are rotated by an external pump motor at rotation shaft 122 which can be coupled to a pully or the pump motor directly. An example of the behavior under rotation of the lobes is, in a 0-Degree Position fluid flows through the upper lobe, while sealed on the lower lobe. In a 90-Degree Position Fluid flows through the lower lobe, while sealed on the upper lobe. In a 180-Degree position fluid flows through completing the cycle (and any large objects also are transferred through for disposal). Some displacement pumps can remove obstructions and waste up to a 2″ size. The displacement pump then has a much preferable capability to a simple vacuum. Other displacement pump types may be substituted.

The embodiments makes use of a new class of pumps controlled with variable speed feedback from the auger motor 22. Specifically, we have discovered an effective system configuration that provides automated filtration within a range of waste content, has no requirement for waste buildup or manual removal, and enables closed loop heat exchange or recovery from the waste stream. The waste heat system enables ongoing continuous waste filtration for continuous efficient heat recovery from waste streams.

The system can be arranged and configured for useful thermal applications, for example heat recovery or heat exchange with municipal waste streams like sewage, sewage storage tanks in buildings, or industrial waste storage or streams. Typically heat exchange systems potentially require the fluid for exchange to be “clean” and have low waste content, as can be achieved with the waste filtration system 2.

FIG. 6 shows a schematic of control of waste filtration system 2, by a controller (computer) 26. Control communications links to elements (solid or dashed lines) are not numbered. Incoming waste stream 4 has a waste content, flow rate or pressure. In alternative embodiments the flow rate or pressure of incoming stream is controlled by an inlet pump 80 to be maintained within a range. In some scenarios, the incoming waste content has particulate size greater than 5 mm, for which an optional in-line macerator 82, can be operated to reduce the size of particulate below an acceptable size (for example less than 2 mm preferred for heat exchange applications). Incoming waste stream 4 then enters housing 6 for filter processing in waste filtration system 2. Motor 22 controls auger rotation and an integrated variable speed motor sensor 24 or controller (not shown) measures load on the auger 18 corresponding to level of waste content or viscosity of waste stream. As previously described this load is correlated to a small frequency shift of the motor speed as it adjusts to a change in load. The rate of extraction by waste extractor 20 is controlled by controller 26 in response to the variable speed motor frequency shift measurement, to maintain the outgoing filtered stream 5 to have a waste content and viscosity below the target setpoint. The adjustment of extraction rate is fast and dynamic, able to respond to changing inputs and variable loads of a sewage waste stream. In the embodiment with lobe displacement pumps, the pump motor drive is controlled to change the pump rate directly.

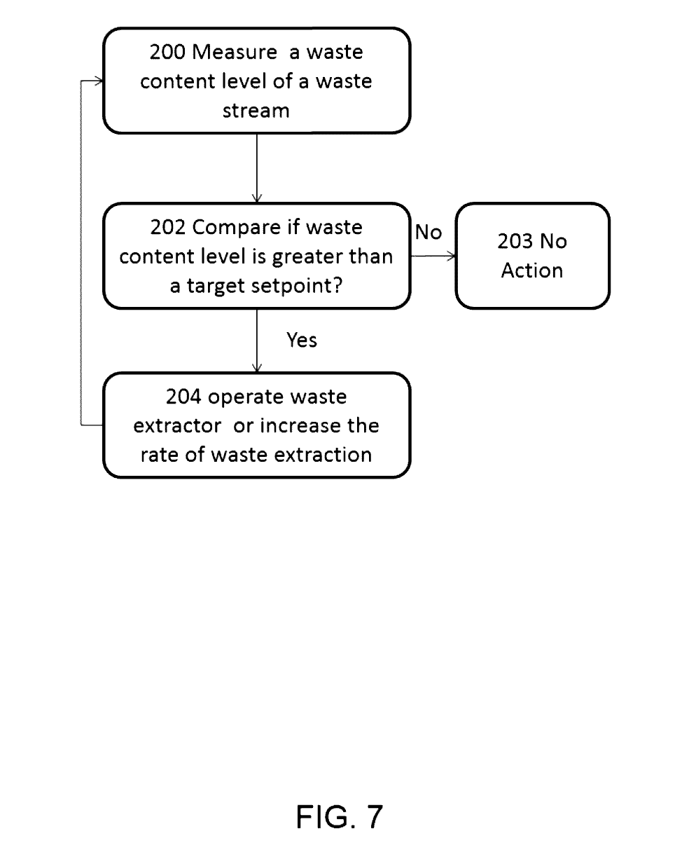

FIG. 7 is a flowchart of a process for feedback control of the waste filtration system. The feedback control for a dynamically responding, closed loop, automated filtration system, is shown in general steps.

In step 200, a waste content parameter of a waste stream is measured (correlated to viscosity of the stream). This monitoring may be measured a number of alternative ways and still provide effective control. Most important is to measure or correlate to the waste content in the chamber (more specifically inside the screen or “filtering” zone). The embodiment with feedback control from variable motor speed sensing is elegant simple, direct and rugged. Various alternatives are described in more detail in FIG. 9, and listed briefly here. One alternative is a direct load sensor 33 on the auger or shaft, correlated to viscosity or waste content. Another alternative is upstream and downstream pressure sensors to determine pressure differential and rate of change of pressure differential, and correlate to a target waste content. A more complex and costly alternative is turbidity or viscosity sensors on incoming and outgoing streams. Each of these examples could have different set-point programming to the controller 26. These other alternatives would not require a variable speed motor in the embodiment, and could function with a steady state motor. Typically the variable speed motor is operated continuously (excepting during repair or maintenance).

In Step 202, the measurement of step 200 is compared to a stored setpoint. If the waste content reading is greater than the setpoint, then the process proceeds to step 204 where the controller either initiates extraction or increases the extraction rate of the extraction pump (through increasing the pump drive speed). If the waste content is less than the setpoint, then no action is taken (Step 203), where no action means no change to the existing variable speed motor speed. The process runs continuously but an alternative is to run filtering on demand if the application benefits. Once the target has been reached optional additional steps can be added to reduce the extraction rate to a minimum setting for efficiency while continuing to monitor waste content level and increase extraction rate.

Providing a closed loop, reliable, automated filtration system of waste water is of great benefit to realize continuous large scale heat exchange or recovery. To enable the filtration system use in heat exchange arrangements, it is important to provide a waste filtration process producing and maintaining a low waste content stream which retains substantial original heat. High high waste content>5% or large particulate or debris does not meet requirements of commercial heat exchangers and may damage or inhibit heat exchangers.

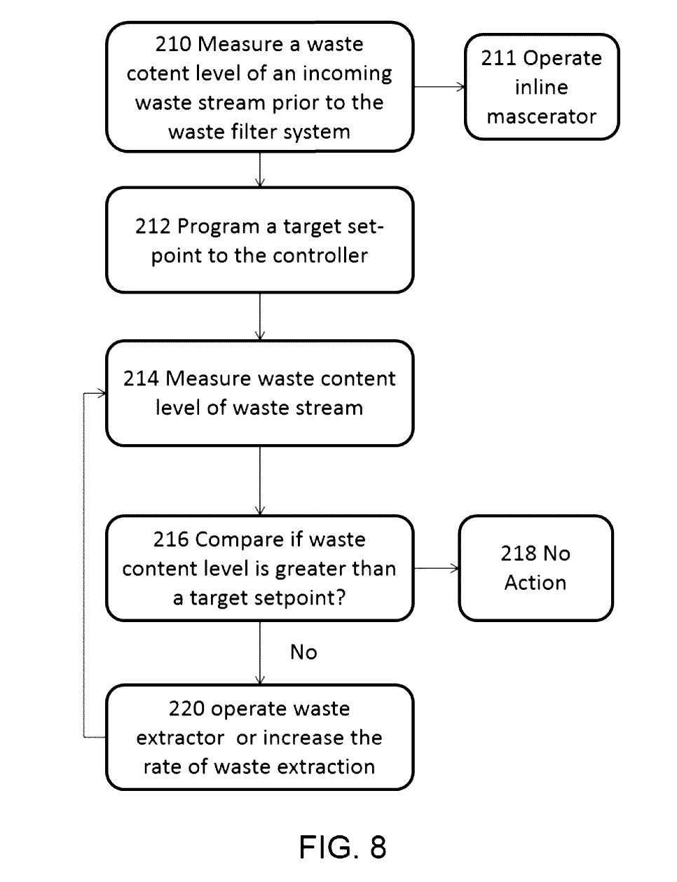

FIG. 8 is a flowchart of an additional process providing feedback control of the waste filtration system, referencing the schematic of FIG. 6.

It is desired to achieve a continuous filtering within the waste filtration system and various additional steps allow for adjustment for incoming waste content and waste stream properties. For example, process and component changes with improved extraction and control sensitivity. The preferred operating range of a sewage waste water system is 0-5% content of waste. In some embodiments it may be desireable to use a different range.

In step 210, particulate size measurement for an incoming waste stream prior to the waste filtration system 2, is compared to a threshold (through particulate size sensor not shown or numbered). If the size is larger than a target setpoint (example 5 mm size), then in step 211 inline macerator 82 is operated and continues until the size is measured less than target. In an embodiment the size measurement may be integrated within the macerator system. If the size measurement is smaller than target setpoint, then the control process of FIG. 7 is invoked in steps 214 to 220, corresponding respectively to steps 200-204. The particulate size sensing can be either continuous and dynamic or programmed for heavy load periods etc. The macerator operation optionally can be controlled to last an extended or minimum period once triggered. The benefits of such additional control process is improved automation and reduced maintenance by conditioning the incoming waste stream to remain within acceptable parameters.

FIG. 9 shows additional feedback sensors and alternative arrangements for measuring waste content both directly and inferred. An alternative is a direct mechanical load sensor 33 associated with or on the auger 18 or shaft 21 and in communication with the controller or computer 26, that provides a load measurement correlated to viscosity or waste content. Such a mechanical sensor 33 needs to have suitably high precision. Sensor 33 can enable other conventional motors to be used to drive the auger 18 at a set speed instead of a the variable speed motor type. Another alternative feedback control uses two pressure sensors 40,41 for measuring pressure differential across the inner chamber 7 and rate of change of pressure differential, and correlate those measurements to a target viscosity of waste content. Sensor 40 is located upstream of the filtration system 2, or optionally at or inside the chamber near the inlet port. Sensor 41 is located downstream of the filtration system 2, or optionally at or inside the chamber near the fluid outlet port 10. A more complex and expensive alternative is that sensors 40, and 41 are substituted by turbidity or viscosity sensors measuring the change between incoming and outgoing streams 4,5, and deriving a waste content level or parameter. In an additional special case of the previous alternative, is that only downstream sensor 41 is used where it provides adequate and precise monitoring of waste content (i.e. is a viscosity or turbidity meter). Each of these alternative feedback controls necessitates different set-point programming to the controller 26, to calibrate the measurements to the desired waste content level.

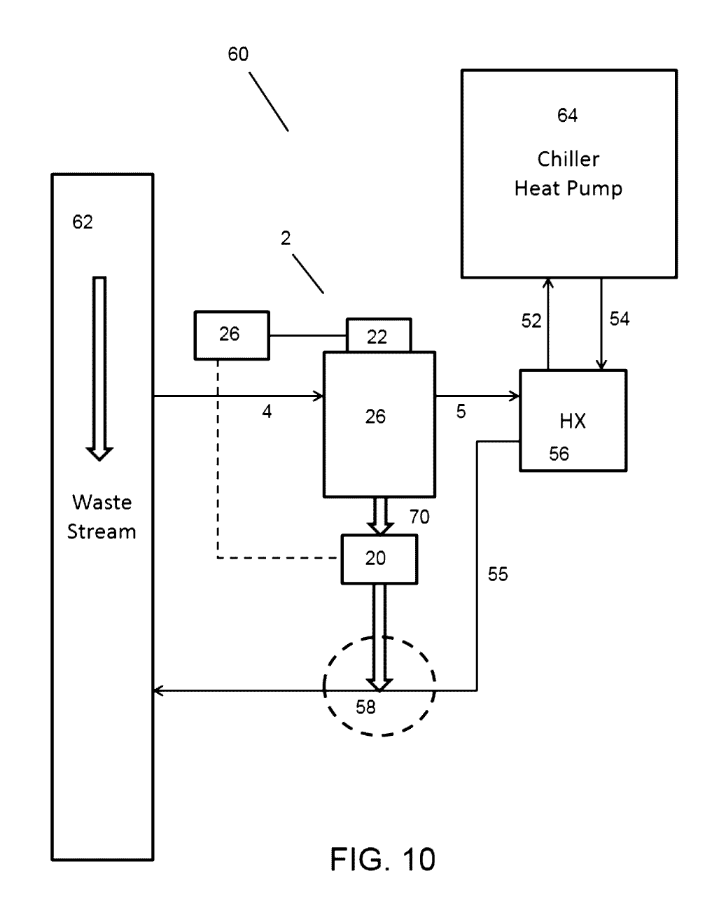

Providing a closed loop, reliable, automated filtration system of waste water is of great benefit to realize continuous large scale heat exchange or recovery. To enable the filtration system use in heat exchange arrangements, it is important to provide a waste filtration process producing and maintaining a low waste content stream which retains substantial original heat. High waste content>5% or large particulate or debris may not meet requirements of commercial heat exchangers and may damage or inhibit heat exchangers. Arrangements of use of the waste filtration system in heat exchange applications are shown in FIGS. 10-14. The heat exchange arrangements are applicable to a wide range of consumer and industrial end users, for example municipal structures, apartments, office buildings, and industrial facilities.

FIG. 10 shows a schematic of a waste filtration system 60 integrated with a heat exchange loop for heat recovery from a waste stream, incorporating novel closed loop recycling of removed waste. A waste stream 62 (such as a municipal waste stream), is accessible for diversion and coupling, and flow direction indicated by the arrow. A waste stream 4 is diverted from waste stream 62 through a conventional conduit coupled to the fluid inlet port 8 to waste filtration system 2 operating to separate waste solids or semi-solids through a waste extractor 20. Waste content is measured of the processed waste stream within or outgoing from chamber 7 of housing 6, using one of the feedback control arrangements described previously (and in the preferred case the speed shift of the variable speed motor 22). Controller 26 compares waste level reading to a setpoint, and if greater than setpoint, the controller 26 operates waste extractor 20 or increases the rate of extraction of waste extractor 20, such that the viscosity or waste level inside and exiting waste filtration system 2 at outgoing filtered stream 5 is within an acceptable target range suitable for use in heat exchanger systems. This acceptable range is less than 5% waste content.

In the example of waste sewage, the outgoing filtered stream 5 retains warm or “greywater” heat suitable for recovery, and is directed to a heat exchanger 56 for extracting heat via an exchange fluid which is transferred via stream or conduit 52 to chiller heat pump 64 and a return stream or conduit 54 returning the cooled exchange fluid stream to heat exchanger 56. The exchange fluid remains in a closed loop between heat exchanger 56 and chiller heat pump 64. In one embodiment, Chiller heat pump 64 is air cooled and water heating type, and thermally connected to an indoor space (not shown) for heating. The heat pump and heat exchanger have electronic communications for dynamic control (typically the heat exchanger controls the heat pump). Following heat extraction, the outgoing filtered stream 5 then exits the heat exchanger 56 in return stream or conduit 55 that returns the filtered cooler stream back to the waste stream 62 for downstream disposal. In this example, the removed waste is collected for removal and disposal. A preferred embodiment has a closed loop to remix and send back the extracted waste, eliminating space for storing waste, health risks and smells from open waste, and manual labor to manage the process. The preferred embodiment connects the extracted waste from waste extractor 20 to return conduit 55 for the purpose of remixing the extracted waste back into the returning cooler stream. Optionally, a remixing pump (or mixer) 58 is coupled between the waste extractor stream and return conduit 55 to enhance continuous automated mixing. Hence an efficient, reliable, closed loop system is provided to continuously filter waste to provide a cleaner stream, extract heat from the waste stream, then return both solid waste and the stream, back to it's source, for example municipal sewage lines.

Any of the feedback control alternatives are suitable for waste filtration system 60 integrated with heat exchange system.

Some heat exchange applications include a waste storage tank (typically coupled to the municipal sewage line 62), for example used in buildings for the purpose of temporary storage of waste, providing an additional source of waste stream having extractable heat.

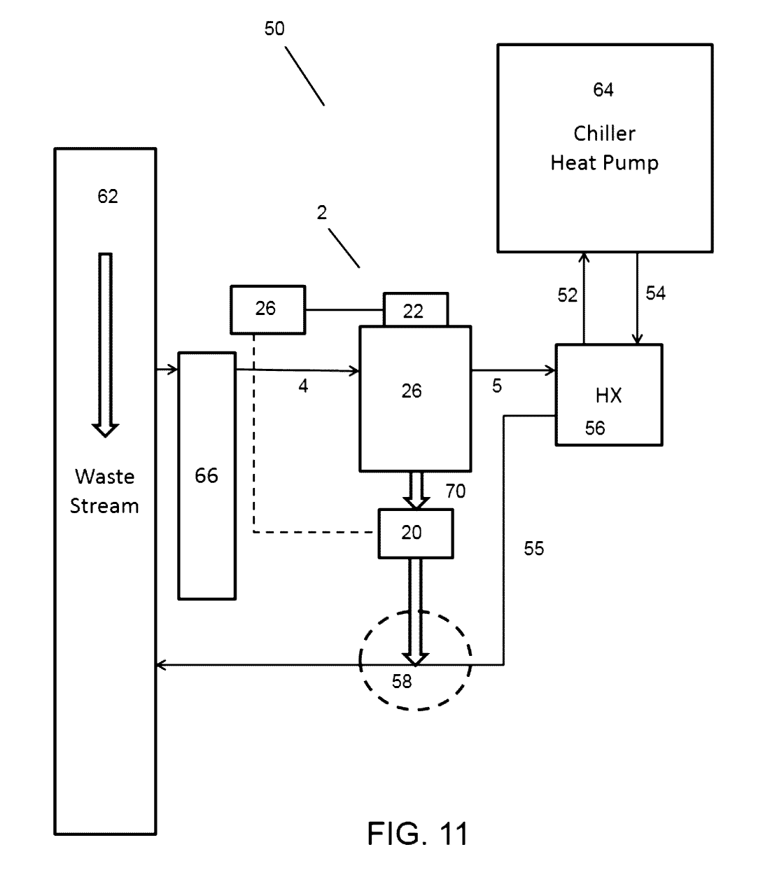

FIG. 11 shows a schematic of a waste filtration system 50 used in a heat exchange loop for heat recovery from a waste storage tank, including optional closed loop recycling of removed waste. In some applications, for example large apartment buildings or industrial facilities, waste is temporarily stored in a waste storage tank 66, however still contains latent heat that can be usefully extracted. The arrangement and operation is similar as in FIG. 10 with the addition of the waste storage tank 66 after the waste stream 62. In some embodiments an inlet pump 80 (not shown in FIG. 11) is added inline to stream 5, to increase the pressure and hence flow from the tank 66. Alternatively, the lower region of stored waste is under pressure from weight of the fluid, and can be extracted under pressure through a control valve (not shown). As known to one skilled in the art, additional pumps (not shown) may also be added to provide a pressurized waste stream. The waste storage tank 66, is typically coupled to a waste stream 62 and the return conduit 55 returns to the sewage line (waste stream) 62, and may include optional mixer 58 for full closed loop operation. Hence an efficient, reliable, closed loop system is provided to continuously filter waste to provide a cleaner stream, extract heat from the waste stream, then dispose both solid waste and the stream, either to the waste storage tank 66 or preferably the sewage line (waste stream) 62.

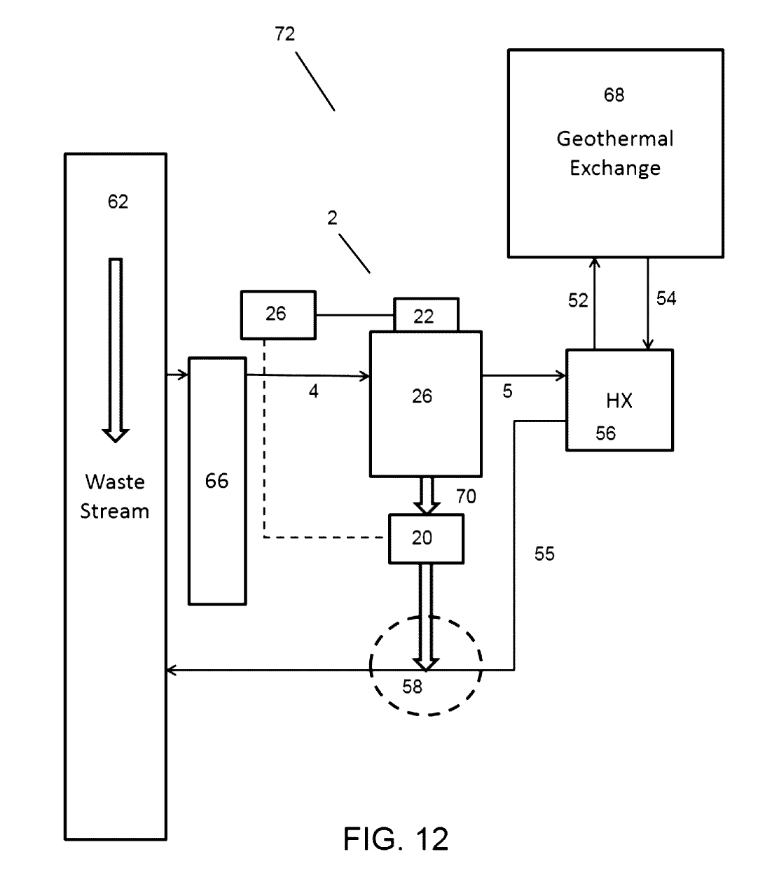

FIG. 12 is a schematic of the waste filtration system 72 used in a geothermal heat exchange loop for heat recovery from a waste storage tank and sewage line 62, including optional closed loop disposal of extracted waste. The arrangement and operation is as in FIG. 11 with the substitution of a geothermal exchange system 68 for chiller heat pump 64, the geothermal exchange system typically has a ground loop providing a hot or cool side for exchange, and efficiency is improved by the increased heat provided by the heat exchanger 56 using grey water filtered by waste filtration system 2. The may include optional mixer 58 for full closed loop operation. An example of a benefit is it allows the elimination of one heat exchanger by increasing the temperature of the stream incoming to the geothermal exchange system 68 by 1-5 deg C., the coefficient of performance of the heating system can be improved 100%. The geothermal exchange system 68 is in electronic communication with the heat exchanger 56 for optimizing control of heat exchange.

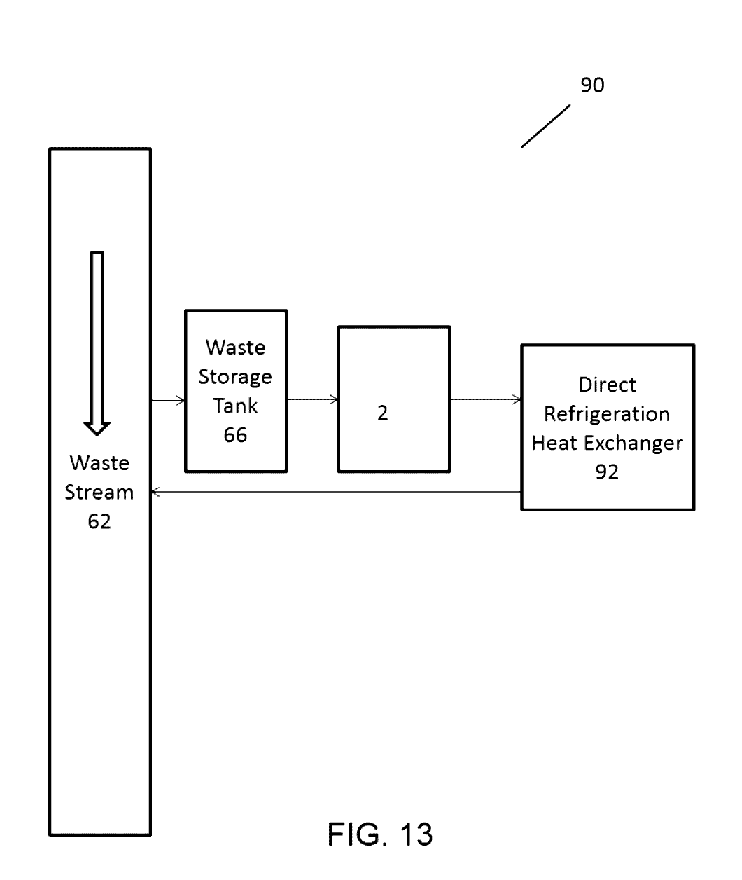

FIG. 13 is a schematic of a waste filtration system 90 integrated with a direct refrigeration heat exchange 92 for cooling from a waste storage tank 66 coupled to a waste stream 62, including optional closed loop recycling of removed waste. Conventional conduits deliver the fluid through the loop (unnumbered).

FIG. 10-12 show sewage and waste storage for illustration, however waste filtration system can be configured to other arrangements including industrial waste or direct greywater recovery. For applications in sewage, the lobe type pumps are preferred, as shown in FIG. 5A.

This automated feedback control is further confirmed during heat recovery where the rate of heat recovery is shown to be independent of changes in waste content. The waste filtration system is preferably positioned vertically but is operable alternatively at an incline or horizontal at either slower removal rate or requiring increased rate of extraction by the pump. The waste filtration system extracts incoming waste for long periods continuously, with minimal reduction in flow rate. Therefore the waste filtration system is suitable to safely and efficiently process waste streams for heat recovery over a wide range of incoming waste stream conditions, enabling efficient heat recovery from waste water including for industrial or residential heating.

The waste filter system further allows for convenient fast and simple replacement of key consumable parts including the auger and filter screen, which is advantageous to maintaining high uptime and reliability. There are several novel benefits of the filtration system. Firstly, the control of displacement pump extraction rate by speed sensing of the auger. Secondly. providing a closed processing loop for waste extraction and replacement. Thirdly, in comparison to alternate filter systems, the waste filtration system has self cleaning features to manage fibrous or large waste, enabling extended use before replacement of parts. Fourthly, significant performance improvement is provided to heat exchange systems from the recovered heat from a previously challenging to extract effectively from, source of continuous heat.

The adaptive response of the system allows the stream to remain in closed loop while having heat extracted, such that separated waste is mixed back into the filtered stream to return for example to the municipal waste stream downstream.

The waste filtration system is found to continuously maintain the outgoing stream waste content within a range while the input stream rate and waste content varies. The separated waste is passively drained by gravity and assisted where needed by vacuum, suitable for reliable continuous automated use, while not requiring pre-filtering the incoming waste stream. The filter waste system is an unusual and fortunate discovery based on prototype testing of standard pump components leaking, heat recovery not possible as the stream was unsuitable for recirculation, and requiring heavy pre-filtering and manual removal of waste. Hence, the waste filtration system represents an ideal waste processing system for heat recovery suitable for wide range of incoming waste, automated operation, and less or none manual cleaning or stopping required.

Another benefit and novelty of using the waste filter in heat recovery is the process for feedback control is implemented in various sensor arrangements.

Alternate arrangements for waste extraction are known that can and are included herein as operable to filter waste water.

While the embodiments are described for use with, they may be also be used in a wider range of waste heat recovery applications in general. The embodiments described herein have solved these various unmet needs in an efficient, effective and integrated manner.

While particular elements, embodiments and applications for the present system have been shown and described, it will be understood, of course, that the system embodiments are not limited thereto since modifications may be made by those skilled in the art without departing from the scope of the present disclosure, particularly in light of the foregoing teachings.

1-28. (canceled)

29. A filtration system for filtering a waste stream having waste content, comprising;
a) a housing having an inner chamber, including
i) a fluid inlet port sealably couplable to an incoming waste stream,
ii) a fluid outlet port sealably couplable to an outgoing fluid conduit,
iii) an extraction port, and
iv) a drive port,
b) a substantially cylindrical filter sleeve seated within the chamber between the drive and extraction ports, and in contact with the fluid inlet port and having an inner diameter and at least a portion of sides and bottom perforated,
c) a rotatable helical shaft, wherein the shaft is rotatably couplable through the drive port,
d) a waste extractor coupled to the extraction port controllable to provide variable negative pressure within the chamber,
e) a motor coupled to the helical shaft for rotating the shaft to separate waste, and translate waste towards the extraction port,
f) a waste content sensor,
g) a computer connected to the waste content sensor, the motor and the waste extractor and stored data to correlate the waste content sensor readings to a waste content level,
wherein, the rate of waste extraction is controlled by the computer to maintain the waste content level below a set point, such that the outgoing waste stream has low waste content.

30. The filtration system of claim 29, whereby the outgoing stream has less than 5% waste content.

31. The filtration system of claim 29, wherein the motor is a variable speed motor, and waste content sensor comprises an integrated frequency shift reader, whereby the frequency shift varies with load on the helical shaft and is correlated to waste content level.

32. The filtration system of claim 31, whereby the speed of the variable speed motor is adjustable to increase rotation rate of the helical shaft.

33. The filtration system of claim 29, wherein the waste content sensor is a mechanical load sensor coupled to the helical shaft.

34. The filtration system of claim 29, wherein the sensor is located downstream of filter sleeve and is one selected from the group of viscosity or turbidity.

35. The filtration system of claim 29, wherein the waste content sensor is upstream of the filter sleeve and further comprising a second waste content sensor downstream of the filter sleeve, for measuring a pressure differential correlated to waste content level.

36. The filtration system of claim 29, wherein the waste extractor is a displacement type pump.

37. The filtration system of claim 36, wherein the displacement pump is one selected from the group of lobe pumps, progressive cavity pumps, vane pumps and gear pumps.

38. The filtration system of claim 37, wherein the pump is semi-sealable with large object extraction.

39. The filtration system of claim 29, wherein the housing is formed by a tube with top and bottom endcaps, such that the top endcap is removable for rapid slide out of the filter sleeve for maintenance.

40. The filtration system of claim 29, wherein the chamber is hermetically sealed.

41. The filtration system of claim 29, wherein the helical shaft axis is vertical.

42. The filtration system of claim 29, wherein the rotatable helical shaft is an auger with a diameter substantially corresponding to the inner diameter of the filter.

43. The filtration system of claim 42, further comprising spring loaded blades coupled to the auger edges to scrape and self-clean the filter sleeve.

44. The filtration system of claim 29, further comprising spring loaded blades coupled to the shaft to scrape and self-clean the filter sleeve.

45. The filtration system of claim 29, further including a conduit exiting waste extractor and returning waste to a municipal sewage line forming a closed sealed loop.

46. The filtration system of claim 29, further including a macerator prior to inlet port, to reduce incoming waste size below a threshold.

47. The filtration system of claim 29, further including guides secured to the bottom of the helical shaft for directing waste into the extraction port efficiently.

48. A method of extracting waste and filtering a waste stream, the steps comprising;
a. measuring a waste content level associated with the filtration system,
b. comparing if the waste content level is greater than a set point level,
c. then increasing the extraction rate of waste extractor until the waste content level is less than the set point level.

49. The method of claim 48, wherein in step c) the speed of variable speed motor is adjustable.

50. The method of claim 48, further comprising additional steps of;
d. measuring incoming waste content size,
e. if greater than a set point, operating the inline macerator to reduce the content size,
f. storing a target waste content set point to the controller,
g. storing a lookup table associated with the sensors and correlated to waste content, to the controller,

51. A filtration system incorporating heat recovery from a waste stream, comprising;
a. a waste filtration system receiving incoming stream from the waste stream, and automatically and continuously controlling waste extraction to maintain waste content below a threshold suitable for heat exchanger use,
b. a heat exchanger fluidically coupled to the waste filtration system for receiving outgoing filtered stream from the waste filtration system, and delivering a return cool stream back to the waste stream,
c. a chiller heat pump fluidically coupled to the heat exchanger for receiving the warm stream and returning a cool stream, such that the coefficient of performance of the chiller heat pump is increased.

52. The filtration system of claim 51, further comprising a waste storage tank between a municipal waste stream and the filtration system, whereby the incoming stream is received from the waste storage tank.

53. The filtration system of claim 51, whereby the extracted waste of filtration system is fluidly coupled and mixed with the return cool stream, such that the circulation loop of the waste stream is closed and sealed.

54. The filtration system of claim 53, further comprising a mixer to remix the waste content back into the return cooled stream.

55. A filtration system incorporating heat recovery from a waste stream, comprising;
a. a waste filtration system receiving incoming stream from the waste stream, and automatically and continuously controlling waste extraction to maintain waste content below a threshold suitable for heat exchanger use,
b. a heat exchanger fluidically coupled to the waste filtration system for receiving outgoing filtered stream from the waste filtration system, and delivering a return cool stream back to the waste stream,
c. a geothermal exchange system fluidically coupled to the heat exchanger for receiving the warm stream and returning a cool stream, such that the coefficient of performance of the geothermal exchange system is increased.

56. The filtration system of claim 55, further comprising a waste storage tank between a municipal waste stream and the filtration system, whereby the incoming stream is received from the waste storage tank.

57. The filtration system of claim 55, whereby the extracted waste of filtration system is fluidly coupled and mixed with the return cool stream, such that the circulation loop of the waste stream is closed and sealed.

58. The filtration system of any one of claims 55, further comprising a mixer to remix the waste content back into the return cooled stream.
